(19) United States
(12) Patent Application Publication
(10) Pub. No.: US 2015/0292540 A1
(43) Pub. Date: Oct. 15, 2015

(54) WEDGE CLAMPING SYSTEM FOR BEAMS

(71) Applicant: Natel Energy, Inc., Alameda, CA (US)

(72) Inventors: Erick M. DAVIDSON, Oakland, CA (US); Abraham D. Schneider, San Francisco, CA (US)

(73) Assignee: Natel Energy, Inc., Alameda, CA (US)

(21) Appl. No.: 14/661,214

(22) Filed: Mar. 18, 2015

Related U.S. Application Data
(60) Provisional application No. 61/977,196, filed on Apr. 9, 2014.

(51) Int. Cl. F16B 9/02; F16B 2/14

(52) U.S. Cl. CPC F16B 9/023; F16B 2/14

(57) ABSTRACT

A wedge clamp comprises a wedge with an inclined face and an endplate with a pocket that has a mating inclined face. A beam has a curved clamping surface that engages the wedge and a lower surface that engages the endplate. The beam is clamped in the endplate by preloading the wedge into the endplate pocket.

### STATEMENT REGARDING FEDERALLY SPONSORED RESEARCH OR DEVELOPMENT

This invention was made with Government support under grant Award Number DE-SC0003343 awarded by the U.S. Department of Energy. The Government has certain rights in the invention.

### BACKGROUND

This application relates to clamps, particularly to clamps for beams subjected to high cycle fatigue. The ability to clamp a beam of irregular cross-section in a confined space such that it transfers high loads and moments over millions of stress cycles is desirable for a number of reasons. Machinery found in many industries incorporate beam-like structures subjected to high cycle fatigue. Oftentimes these components would be easier to manufacture and/or maintain if the beam could be easily disassembled from its end-constraint. Examples include aero- and hydro-turbine blades or foils; material-carrying buckets in bucket elevators; bars in trough-chain conveyors, and etc.

Traditionally, beams have been attached to their endplates by an adhesive joint, welded joint, or fastener joint. Adhesive joints require special surface preparation for the adhesive to work properly and adhesives tend to be messy. Also, due to the low strength of adhesive joints, they require a substantial surface area to support significant loads. Welded joints only work for metal to metal attachments and have poor fatigue properties. Joints made with fasteners, such as a bolted joint, require features to be put in the mating parts such as holes and flanges. These extra features create stress concentrations, which are a problem for high cycle fatigue. Wedge clamps are an alternative to a fixed joint.

The present invention, therefore, provides a wedge clamp system for use in a variety of demanding applications using various types of beams with various cross-sectional shapes.

### BRIEF DESCRIPTION OF THE DRAWINGS

FIG. 1 is a perspective view of a wedge clamp in accordance with one aspect of the invention.

FIG. 2 is a perspective view of a wedge clamp in accordance with one aspect of the invention.

FIG. 3 is an exploded view of a wedge clamp in accordance with one aspect of the invention.

FIG. 4 is a schematic cross sectional view of the wedge clamp shown in FIG. 1.

FIG. 5 is an exploded view of a wedge clamp in accordance with one aspect of the invention.

FIG. 6 is a schematic cross sectional view of the wedge clamp shown in FIG. 5.

FIG. 7 is a perspective view of a beam supported by two wedge clamps in accordance with one aspect of the invention.

### PARTS LIST

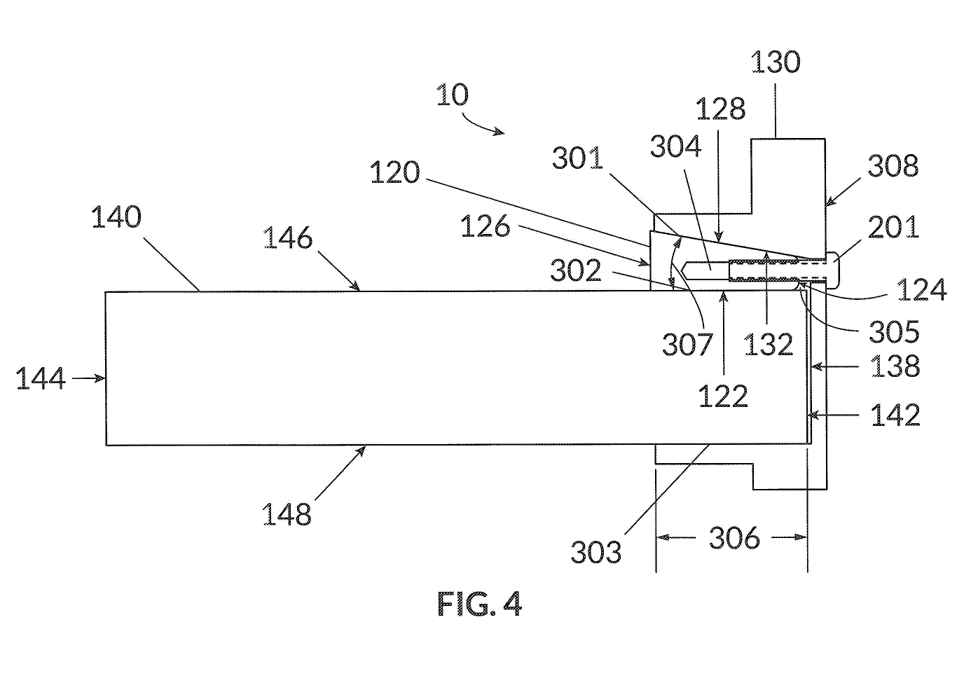

Wedge clamp system
120 Wedge
122 Wedge second face
124 Wedge forward end
126 Wedge rearward end
128 Wedge incline face
130 Endplate
131 Pocket
132 Endplate inclined face
134 Endplate lower face
136 Endplate open end
138 Endplate rearward end
140 Cantilever Beam 142 Beam front face
144 Beam end face
146 Beam upper curved surface
148 Beam lower surface
201 Fasteners
301 Endplate-wedge interface
302 Wedge-beam interface
303 Beam-endplate interface
304 Hole
305 Gap
306 Clamp distance
307 Wedge angle
308 Endplate back face
400 Exploded view of a third embodiment of the present invention
402 Plug
403 Plug upper face
404 Plug lower face
406 Hollow beam pocket
500 Section view of the clamp shown in FIG. 4
501 First hollow beam-plug interface
502 Second hollow beam-plug interface
1010 Wedge clamp system
1120 Wedge
1130 Endplate
1140 Cantilever beam
1146 Beam upper curved surface
2140 Hollow Beam
2145 Hollow beam pocket upper face
2147 Hollow beam pocket lower face
3010 Dual wedge clamp system
3140 Beam

### DETAILED DESCRIPTION

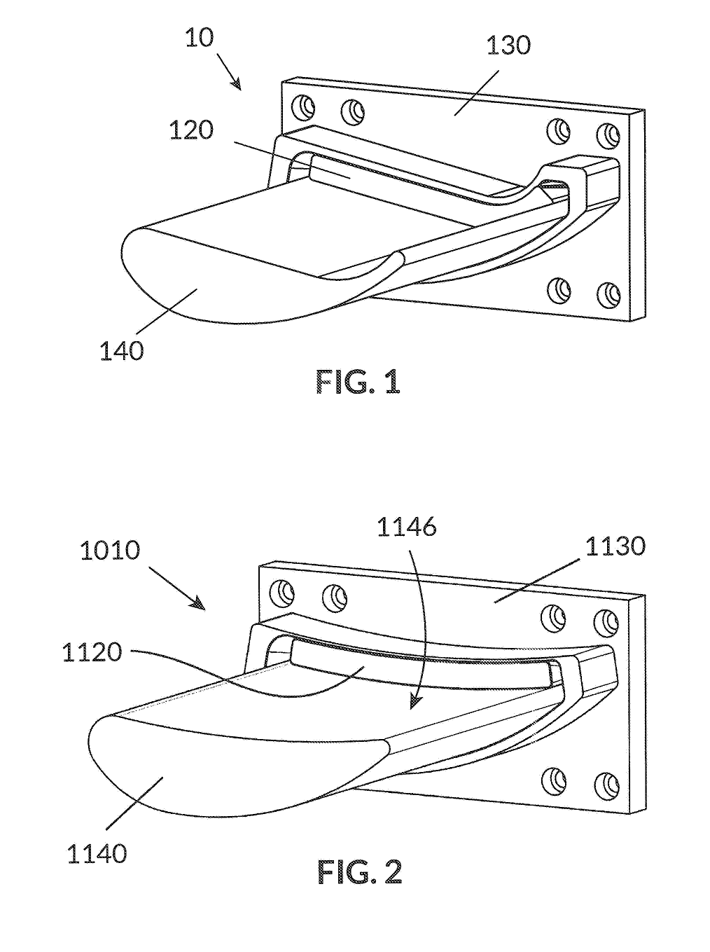

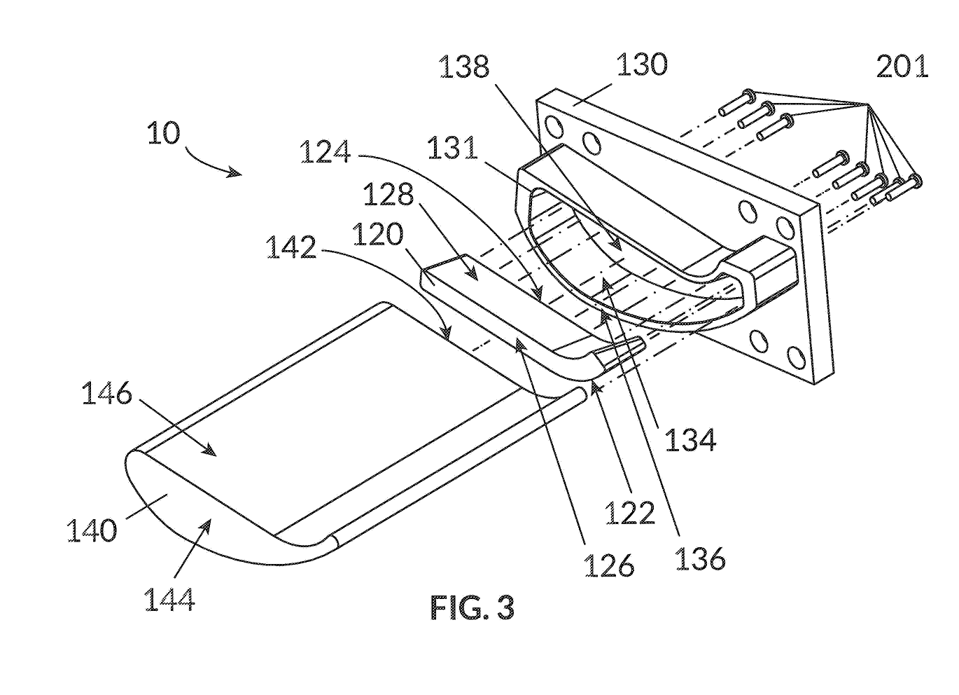

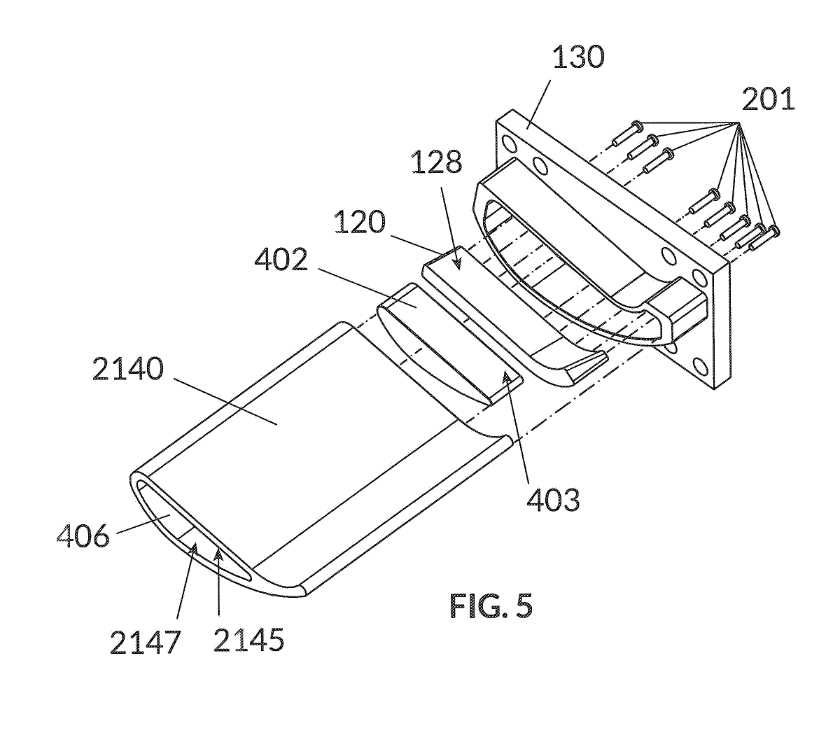

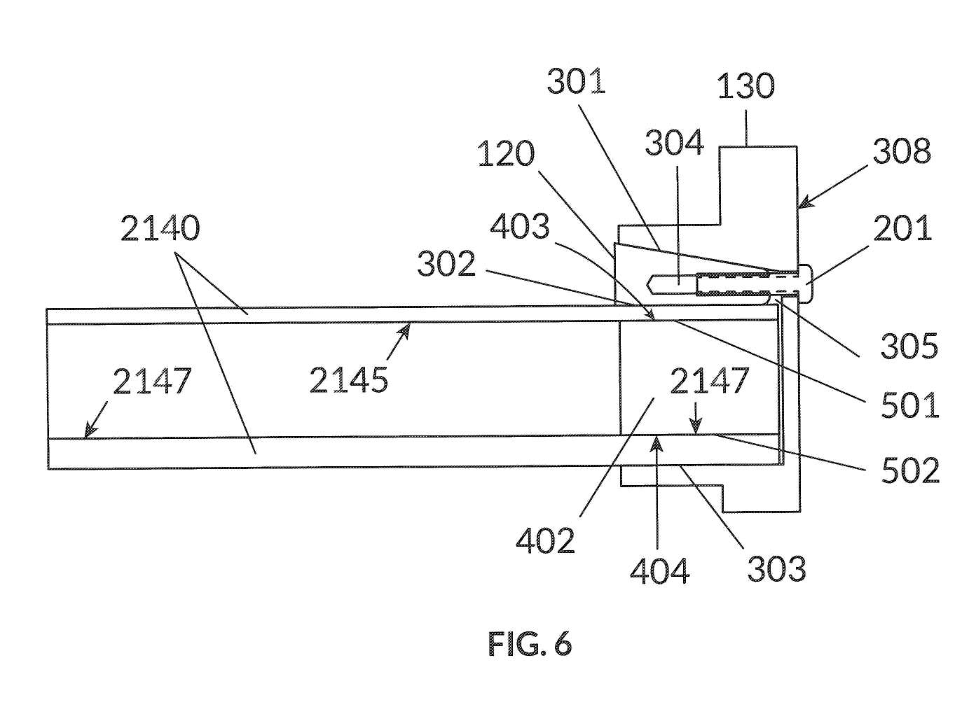

As shown in FIG. 1, wedge clamp system 10 includes endplate 130, wedge 120, and cantilever beam 140. As shown in FIGS. 3 and 5, wedge clamp system 10 can also include fasteners 201. As shown in FIGS. 5-6, wedge clamp system 10 can also include plug 402.

Endplate 130 has a pocket 131 that accepts wedge 120 and beam 140. Placing wedge 120 and beam 140 into pocket 131 creates three interfaces: interface 301 between endplate inclined face 132 and wedge inclined face 128, interface 302 between wedge second face 122 and beam curved upper surface 146, and interface 303 between beam lower surface 148 and endplate lower face 134. Interfaces 301, 302, and 303 provide large contact areas to hold wedge 120, endplate 130, and beam 140 in intimate contact by the friction between the parts at the respective mating interfaces 301, 302, and 303. The frictional force is generated by forcing wedge 120 into pocket 131 such that wedge inclined face 128 slides relative to mating endplate inclined face 132 on endplate 130 resulting in compressive stresses at interfaces 301, 302, and 303. In another aspect of the invention, the frictional force on the three mating interfaces 301, 302, and 303 can be further augmented with an adhesive. In another aspect, the frictional force can be augmented by providing a rough surface on either or both of the face 134 or beam lower surface 148 comprising interface 303. The frictional force can be further modified by other methods known to those skilled in the art, as well as combinations of any of the foregoing.

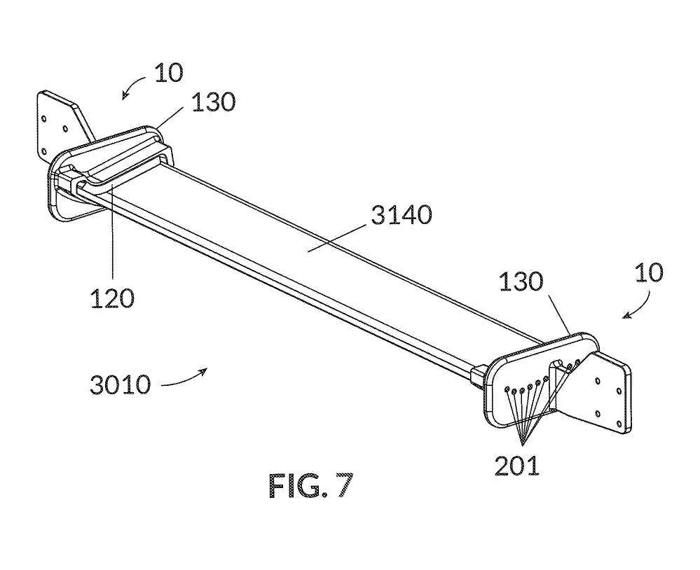

As shown in FIG. 3, wedge 120 can be forced into endplate 130 using fasteners 201 that mate with holes 304 in the wedge 120. For example, fasteners 201 could be screws, nails, pins, rivets, self-tapping screws, machine screws, bolts, and others. In one aspect, fasteners 201 could extend through clearance holes in wedge 120 to a threaded clamping plate. The threaded clamping plate is not shown in figures but is a separate component containing threaded holes to mate with fasteners 201. The threaded clamping plate nominally sits flush with the wedge rearward end 126 and is used to force the wedge 120 into the endplate 130. The threaded clamping plate could be used, for example, if it is preferable to have through holes in a compliant wedge 120 and machine screw fasteners 201 mate with threaded holes in the metal clamping plate. In addition to fasteners 201, wedge 120 can be forced inwards with a press such as an arbor press or hydraulic press, clamps such as C-clamps or bar clamps, or other methods known to those skilled in the art. As shown in FIG. 3, fasteners 201 can have non-uniform spacing along endplate 130. A gap in spacing could be required if, for example, another part is attached to endplate 130 or if endplate 130 has a protrusion as shown in FIG. 7. In one aspect, fasteners 201 can be uniformly spaced from each other by approximately 25 mm along a substantially horizontal axis of endplate 130. In another aspect, the same number of fasteners can be spaced closer to each other in groups with gaps between adjacent groups. In another aspect, additional fasteners 201 can be used to result in a higher clamping load and the ability to support higher beam moments and loads. In one aspect of the invention, a press force of 21.5 kN provides a normal clamp force of 31 kN and can support a moment of 1000 N-m. This example assumes a clamp distance 306 of 35 mm, a coefficient of friction of 0.25 between wedge 120 and beam 140, and a wedge angle 307 of 10 degrees. In this aspect, nine #10 screws are required to apply the press-force of 21.5 kN. A higher clamp force would require either more screws or larger screws.

Endplate 130 can be made from a material that has the strength necessary to support the endplate stresses in wedge clamp system 10. The highest endplate stresses occur at the two ends where the endplate inclined face 132 and the endplate lower lower face 134 meet. For clamp systems that support significant moments, this stress can exceed 100 MPa. Low strength steels such as 1018 steel can have yield strengths as low as 200 MPa and are usually sufficient. However, for high-cycle fatigue situations or higher clamping forces, it may be necessary to use higher strength steels such as 4140 or 17-4Ph, which can have yield strengths higher than 1000 MPa. The stress can also be reduced by providing additional material around the endplate pocket 131. Similarly, beam 140 can be made from any material as long as its strength can support the clamp induced stresses, including difficult to clamp materials such as fiber reinforced plastics, other composites, and ceramics. This is due, in part, to the large, distributed surface contact area at the interfaces 302 and 303, which results in low surface contact stresses, usually less than 5 MPa. Such low stresses are easily sustainable by virtually all engineering materials including polymers. In fact, it has been found that stress concentrations are surprisingly negligible with wedge clamp system 10, and therefore issues such as localized buckling of composite fibers or crack initiation in metals are not an observed problem even over very high cycle fatigue lifetimes of over 100 million cycles.

Beam 140 has an irregular cross-sectional shape that is asymmetrical about the mid-plane. Many other cross-sectional shapes can be envisioned and are acceptable including shapes that are symmetric about the mid-chord, such as might be found in the blades of an impulse turbine. The curved upper surface 146 that mates with wedge second face 122 can have an irregular geometry along the length of the wedge and can follow any path comprised of straight sections, arcs, or splines, or any combination of the foregoing. The beam lower surface 148 can likewise follow any path and does not have to follow the beam curved upper surface 146. FIG. 2 illustrates wedge system 1010 including wedge 1120, endplate 1130, and cantilever beam 1140. Wedge system 1010 utilizes a simpler blade curved upper surface 1146 having a path that follows a single circular arc.

In wedge clamp system 10, wedge 120 is preferably made from a compliant material such as plastic, which allows it to absorb large tolerances in the shape of wedge 120 or endplate 130. Cross-sectional shape tolerances on the order of a millimeter are easily absorbed with a plastic wedge. In one aspect of the invention, wedge 120 can be made of Delrin, acetal, or nylon. For applications with tighter tolerances such as on the order of a tenth of a millimeter, wedge 120 can be made from stiffer materials such as aluminum, bronze, steel, or others. In another aspect, a wedge with a variable modulus of elasticity along its length could be used, for example, in situations where the wedge has to bend around tight radii. In this situation, it might be useful to have the wedge be relatively stiff over the flatter sections and more compliant over the tight bends.

Referring now to FIGS. 5 and 6, wedge clamp system 10 can include hollow beam 2140 and plug 402 to aid in the clamping of hollow beam 2140. Plug 402 stiffens the clamped end of hollow beam 2140 and creates two new interfaces: interface 501 between beam pocket upper face 2145 and plug upper face 403 and interface 502 between plug lower face 404 and beam pocket lower face 2147. These interfaces transfer compressive loads across the pocket 406 in beam 2140. Plug 402 is not necessary in wedge clamp system 10 if the sidewalls of hollow beam 2140 are strong enough by themselves to support the compressive loads across the pocket in beam 2140. Plug 402 should be a close fit with beam 2140 over interfaces 501 and 502 but could be an interference fit or a clearance fit. Plug 402 can be made from any material that can sustain the required stresses of about 5 MPa. Therefore, just about any engineering material, including polymers, will work for the plug.

### Operation

The manner of using wedge clamp system 10 to secure beam 140 involves placing beam 140 into pocket 131 of endplate 130 and using force to draw wedge 120 into position. If plug 402 is required, it can be fit into hollow beam 2140 before assembly with endplate 130. Proper function of wedge clamp system 10 depends on the wedge angle 307, clamp distance 306, frictional properties of the mating materials, and force used to place the wedge 120 in position. The wedge angle 307 is an important parameter for proper function of wedge clamp system 10. Wedge angle 307 is defined as the angle of interface 301 relative to interface 302 in FIG. 4, Everything else being equal, a smaller wedge angle 307 results in a higher clamp force. However, a smaller wedge angle 307 also results in increased longitudinal sliding distance if large tolerances are involved. It is important to size the wedge angle 307 so that over the expected tolerance range, a gap 305 is maintained. If gap 305 is eliminated while forcing the wedge 120 into position, full clamp force will not be achieved. Therefore, a practical lower limit on the wedge angle 307 depends on what clamp force is required and what tolerances are expected. In general, it is desirable to use the smallest wedge angle practical for a given application since this results in the highest clamp force.

There are also upper limits to the wedge angle 307 depending on which embodiment is used. For the first embodiment shown in FIG. 1, the upper limit on the wedge angle corresponds to the angle at which friction alone will no longer hold the wedge 120 in place. The wedge angle 307 results in a force component that acts to urge the wedge 120 out of pocket 131. There are counteracting friction components at interfaces 301 and 302 that act to keep the wedge 120 in place. At the angle where the outward force component equals the sum of the two maximum friction components, the wedge 120 will not stay in place by itself. In one aspect of the invention where a steel endplate, steel beam, and an acetal wedge are used, the coefficient of friction of 0.25 results in an upper limit on wedge angle 307 of approximately 25 degrees. In another aspect of the invention with all steel components and a coefficient of friction of 0.74, the upper limit on wedge angle 307 is 44 degrees. A practical upper limit would be somewhat lower depending on operating condition and what factor of safety is desired; in the case of a plastic wedge, wedge angle 307 can range from approximately 1 degree to approximately 20 degrees. In another aspect, wedge angle 307 can range from approximately 3 degrees to approximately 15 degrees. In a further aspect, wedge angle 307 can range from approximately 5 degrees to approximately 12 degrees. The wedge clamp system 10 could function at a greater wedge angle if fasteners 201 or similar are used to keep wedge 120 in place. The theoretical upper limit on wedge angle 307 in this case is the angle at which fastener or press force is no longer able to overcome the combined frictional components during assembly. For the ease of steel endplate, steel beam, and acetal wedge, this theoretical maximum wedge angle 307 is approximately 75 degrees. However, a practical maximum wedge angle would be lower based on the available force to draw the wedge 120 into position. In this case, wedge angle 307 can range from approximately 1 degree to approximately 40 degrees. In another aspect, wedge angle 307 can range from approximately 3 degrees to approximately 30 degrees. In a further aspect, wedge angle 307 can range from approximately 5 degrees to approximately 20 degrees. In another aspect using all steel components, the coefficient of friction of 0.74 requires a higher press force and therefore wedge angle 307 can range from approximately 1 degree to approximately 20 degrees. In another aspect, wedge angle 307 can range from approximately 3 degrees to approximately 18 degrees. In a further aspect, wedge angle 307 can range from approximately 5 degrees to approximately 15 degrees.

It is apparent from the preceding paragraph that frictional properties of interfaces 301 and 302 are also important for proper function of wedge clamp 10. Everything else being equal, a lower coefficient of friction results in a greater clamp force. A lower coefficient of friction can also result in a lower upper limit on wedge angle. This is usually not a concern, especially when fasteners 201 or similar are used and left in place. It is, therefore, desirable to use mating material combinations at interfaces 301 and 302 that minimize friction such as typical between plastics and metals. For material combinations such as steel on steel that have a high coefficient of friction, it is also possible to lube the surfaces prior to assembly to reduce friction; in the case of steel on steel, coefficient of friction will drop from 0.74 dry to 0.16 when lubed. To this end, it is also desirable that the mating surfaces are as smooth as practical without undue expense. For example, it has been found that standard machining surface finishes are adequate. Optimized surfaces that promote sliding in one direction (wedge 120 insertion) and hinder sliding in the opposite direction (wedge 120 extraction) are also possible and could enhance clamp performance. These optimized surfaces could comprise macroscopic features such as a sawtooth profile or microscopic features such as directional whiskers similar to those used on ski skins. Interface 303 typically does not experience sliding during assembly or operation. Therefore, to prevent sliding at interface 303, the coefficient of friction should be maximized. In one aspect of the invention, wedge clamp system 10 generally provides sufficient clamp force such that interface 303 does not need to be altered to provide the requisite friction force. In another aspect, the friction at interface 303 can be increased by applying an adhesive, roughing endplate lower face 134 or beam lower surface 148, or other methods.

Another important parameter for proper function of wedge clamp system 10 is the clamp distance 306 of wedge clamp system 10, or the longitudinal distance that wedge 120 and beam 140 extend into pocket 131. A greater clamp distance 306 allows wedge clamp system 10 to sustain greater beam moment loads. In one aspect of the invention, a clamp distance 306 of 35 mm will support a moment of 1000 N-m whereas a clamp distance of 50 mm will support a moment of 1400 N-m. In another aspect of the invention, it is desirable to limit the clamp distance 306 to only support the expected beam moments and loads to reduce the part size and cost of wedge clamp system 10.

The press force used to draw wedge 120 into endplate pocket 131 during assembly is another important parameter in proper function of wedge clamp system 10. A greater press force during assembly results in a greater clamp force. The press force should be selected to result in a clamp force that is sufficient to support the beam moments and loads expected. The press force can be achieved with fasteners 201 or clamps as described above. In one aspect of the invention with coefficient of friction of 0.25, wedge angle 307 of 10 degrees, and clamp distance 306 of 35 mm, a press force of 21.5 kN results in a clamp force of 31 kN and moment carrying capacity of 1000 N-m. Press force is linear with clamp force and so doubling the press force would double the clamp force and therefore double the moment carrying capacity of the clamp system.

Unlike glued or welded joints, it is very easy to disassemble the wedge clamp system 10, if necessary. If using fasteners 201, as illustrated in FIGS. 3-7, the fasteners 201 can first be partially removed from the endplate back face 308 so that they remain partially engaged in wedge 120. Next fasteners 201 can be tapped or otherwise forced back towards the endplate 130 to push wedge 120 out of pocket 131. Following some forced movement out of pocket 131, the wedge 120 is easy to remove by hand. All parts of the wedge clamp system 10 can then be readily disassembled and reused as required. Wedge 120 removal for the aspect of FIGS. 1 and 2 would involve either supplying through holes in the endplate 130 similar to the screw holes shown in FIGS. 4 and 6 to tap the wedge 120 out from pocket 131 or supplying features such as holes or a lip on the wedge 120 to aid in forcing the wedge 120 out.

Referring now to FIG. 7, two wedge clamp systems 10 can be used to support beam 3140 between two endplates 130. Beam 3140 can be simply-supported or rigid depending on how endplates 130 are connected to a structure or pair of belts. In one aspect of the invention, beam 3140 can be connected to a wedge claim system at either end including an endplate 130 and wedge 120. Optionally, fasteners 201, can be used to force and maintain wedges 120 in place. Plugs 402 (not shown), could also be used with the respective wedge systems 10 if beam 3140 is hollow.

Assembly of this beam and wedge clamp system 3010 is no different from that of a cantilever beam except that there are two wedge clamp systems 10. This system can, optionally, be assembled in a jig that sets the endplate to endplate distance, which allows for a tight tolerance on endplate to endplate distance despite having a loose tolerance on beam length. The beam 3140 can be a simple extruded or pultruded profile that is roughly cut to length with no additional features. If necessary, it is simple to disassemble all parts as described above for the cantilever beam example.

What is claimed is:

1. A wedge clamp, comprising:
a wedge including:
a first inclined wedge face and a second wedge face, each being located between a wedge forward end and a wedge rearward end; and
an endplate including:
a pocket having a pocket upper inclined face and a pocket lower face between a pocket open end and a pocket rearward end,
wherein the wedge and endplate engage a beam including a beam front face, a beam end face, a beam curved horizontal upper surface, and a beam lower surface, the beam lower surface being arranged to partially engage the endplate at its lower face,
wherein the curved upper surface engages the second wedge face,
wherein the wedge is preloaded in the pocket between the pocket upper inclined face and the beam curved horizontal upper surface.

2. The wedge clamp of claim 1, further comprising:
a plug configured to occupy an interior space in the beam along a beam length corresponding to a clamping distance.

3. The wedge clamp of claim 1, wherein the wedge is preloaded by a press, clamp, or fastener.

4. The wedge clamp of claim 3, wherein the fastener is left in place after preloading and remains an integral portion of the wedge clamp.

5. The wedge clamp of claim 1, wherein the wedge is made from a compliant material.

6. The wedge clamp of claim 1, wherein the wedge is made from a rigid material.

7. The wedge clamp of claim 1, wherein the wedge has a variable modulus of elasticity.

8. A wedge clamp system comprising:
a wedge including:
a first inclined wedge face and a second wedge face, each being located between a wedge forward end and a wedge rearward end; and
an endplate including:
a pocket having a pocket upper inclined face and a pocket lower face between a pocket open end and a pocket rearward end,
wherein the wedge and endplate engage a beam including a beam first end, a beam second end, a beam curved horizontal upper surface, and a beam lower surface, the beam lower surface being arranged to partially engage the endplate at its lower face,
wherein the curved upper surface engages the second wedge face,
wherein the wedge is preloaded in the pocket between the pocket upper inclined face and the beam curved horizontal upper surface.
a second wedge clamp, the second wedge clamp being configured to engage the second end of the beam.

9. A method of clamping a beam, the method comprising:
placing a beam end into an endplate pocket so that a portion of a lower surface of the beam engages an endplate pocket lower face;
mounting a wedge between a beam curved horizontal upper surface and an endplate pocket upper face; and
applying a load to the wedge to cause the wedge to move towards a rearward end of the endplate pocket such that a wedge inclined face engages the endplate pocket upper face and a second wedge face engages the beam curved horizontal upper surface.

10. The method of claim 9 wherein the step of applying a load to the wedge is accomplished with a fastener, a press, or a combination of the press and fastener.

11. The method of claim 9, further comprising:
placing a plug within an interior space in the beam along a beam length corresponding to a clamping distance.

12. The method of claim 9, further comprising:
preloading the wedge by a press, clamp, or fastener.

13. The method of claim 12, wherein the fastener is left in place after preloading and remains an integral portion of the wedge clamp.

14. The method of claim 9, wherein the wedge is made from a compliant material.

15. The method of claim 9, wherein the wedge is made from a rigid material.

16. The method of claim 9, wherein the wedge has a variable modulus of elasticity.
